(19) United States
(12) Patent Application Publication
(10) Pub. No.: US 2008/0116263 A1
(43) Pub. Date: May 22, 2008

(54) READER/WRITER FOR AUTOMATIC VENDING MACHINE

(75) Inventors: Tomonobu Kameda, Honjo-shi (JP); Yasunari Nakajima, Sawa-gun (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Gunma 372-8502 (JP)

(21) Appl. No.: 11/941,386

(22) Filed: Nov. 16, 2007

(30) Foreign Application Priority Data
Nov. 16, 2006 (JP) 2006-309857

(51) Int. Cl. G07F 7/00

(52) U.S. Cl. 235/381

(57) ABSTRACT

The present invention provides a reader/writer for an automatic vending machine capable of easily outputting payment processing information on electronic money even when a main control section of the automatic vending machine operates abnormally. The reader/writer is provided with a detection section that detects an operating condition of a main control section, a switching section that switches, when the detection section detects a predetermined abnormal operation, the connection with the main control section to a connection with a payment information output section provided for the automatic vending machine, and an RW control section that performs control such that payment processing on electronic money is carried out by reading/writing an electronic money balance stored in a contactless IC card based on a signal received from the main control section and when the connection is switched by the switching section, electronic money payment information is outputted from a payment information output section.

### BACKGROUND OF THE INVENTION

1. Field of the Invention

The present invention relates to a reader/writer for an automatic vending machine provided for an automatic vending machine to sell products such as beverage available in cans, bottles, plastic bottles or the like, capable of performing payment processing using electronic money on an information storage medium which stores a balance of the electronic money.

2. Description of the related art

Conventionally, as this type of reader/writer for an automatic vending machine, a reader/writer is known, which is provided so as to be connected to a main control section that controls a control apparatus in the automatic vending machine via a transmission path and is designed to read/write a balance of electronic money stored in a predetermined information storage medium based on a signal received from the main control section and thereby perform payment processing on the electronic money (e.g., see Japanese Patent Publication 2000-20805).

However, according to the above described conventional example, payment processing information on the electronic money is outputted from a payment information output section based on the control of the main control section, and therefore when, for example, the main control section operates abnormally, the payment processing information on the electronic money is no longer outputted from the payment information output section. In this case, in order for the operator of the automatic vending machine to acquire the payment processing information on the electronic money, it is necessary to directly connect an apparatus for acquiring the payment processing information on the electronic money to the reader/writer for an automatic vending machine, which may make confirmation and collection processing of the payment processing information on the electronic money complicated.

### BRIEF SUMMARY OF THE INVENTION

The present invention has been implemented in view of the above described problem and it is an object of the present invention to provide a reader/writer for an automatic vending machine capable of easily outputting payment processing information on electronic money even when a main control section of the automatic vending machine operates abnormally.

In order to attain the above described object, the present invention provides a reader/writer for an automatic vending machine provided so as to be connected to a main control section that controls a control apparatus in the automatic vending machine via a transmission path, comprising detection means for detecting an operating condition of the main control section, switching means for switching, when the detection means detects a predetermined abnormal operation, the connection with the main control section to a connection with a payment information output section provided for the automatic vending machine, and control means for performing control such that payment processing on electronic money is carried out by reading/writing an electronic money balance stored in a predetermined information storage medium based on a signal received from the main control section and when the connection is switched by the switching means, the payment processing information on the electronic money is outputted from the payment information output section.

When the main control section detects the predetermined abnormal operation, control is performed such that the connection with the main control section is switched to the connection with the payment information output section and the payment processing information on the electronic money is outputted from the payment information output section, and therefore when the main control section operates abnormally, the operator of the automatic vending machine can acquire the payment processing information on the electronic money without directly connecting an apparatus for acquiring the payment processing information on the electronic money to the reader/writer for an automatic vending machine. Therefore, the present invention allows the payment processing information on the electronic money to be easily outputted, and thereby allows the operator of the automatic vending machine to confirm and collect the payment processing information on the electronic money in a short time.

### BRIEF DESCRIPTION OF SEVERAL VIEWS OF THE DRAWINGS

FIG. 1 is a perspective view of an automatic vending machine showing an embodiment of the present invention;

FIG. 2 is a side cross-sectional view of the automatic vending machine shown in FIG. 1;

FIG. 3 is a block diagram showing the configuration of a control system of the automatic vending machine shown in FIG. 1;

FIG. 4 illustrates logical circuits of the detection section and switching section;

FIG. 5 shows an example of a data structure of electronic money payment information;

FIG. 6 is a functional configuration diagram of a contactless IC card;

FIG. 7 is a flow chart illustrating the operation of the RW control section when closing processing on payment is performed; and

FIG. 8 is a flow chart illustrating the operation of the RW control section when a product is carried out as a master apparatus.

### DETAILED DESCRIPTION OF THE INVENTION

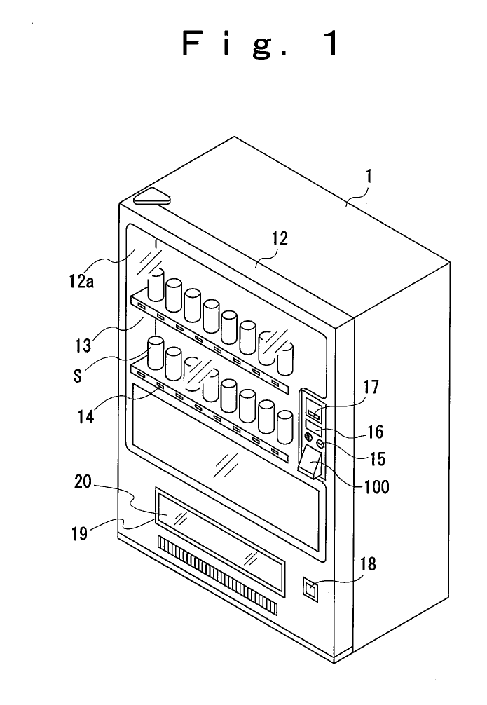

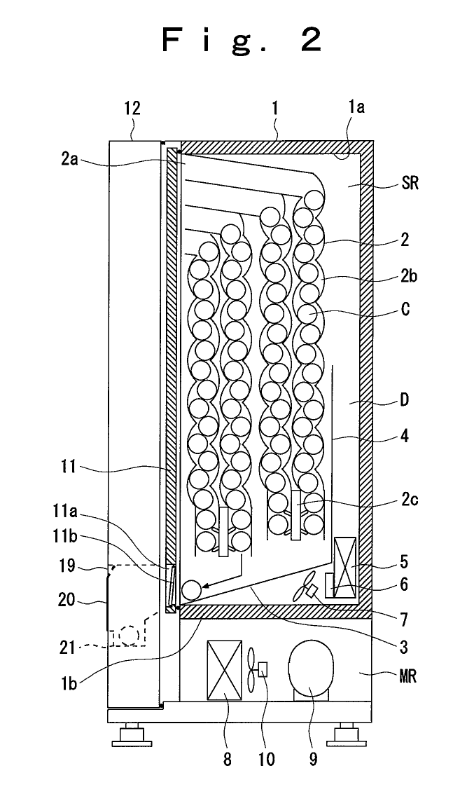

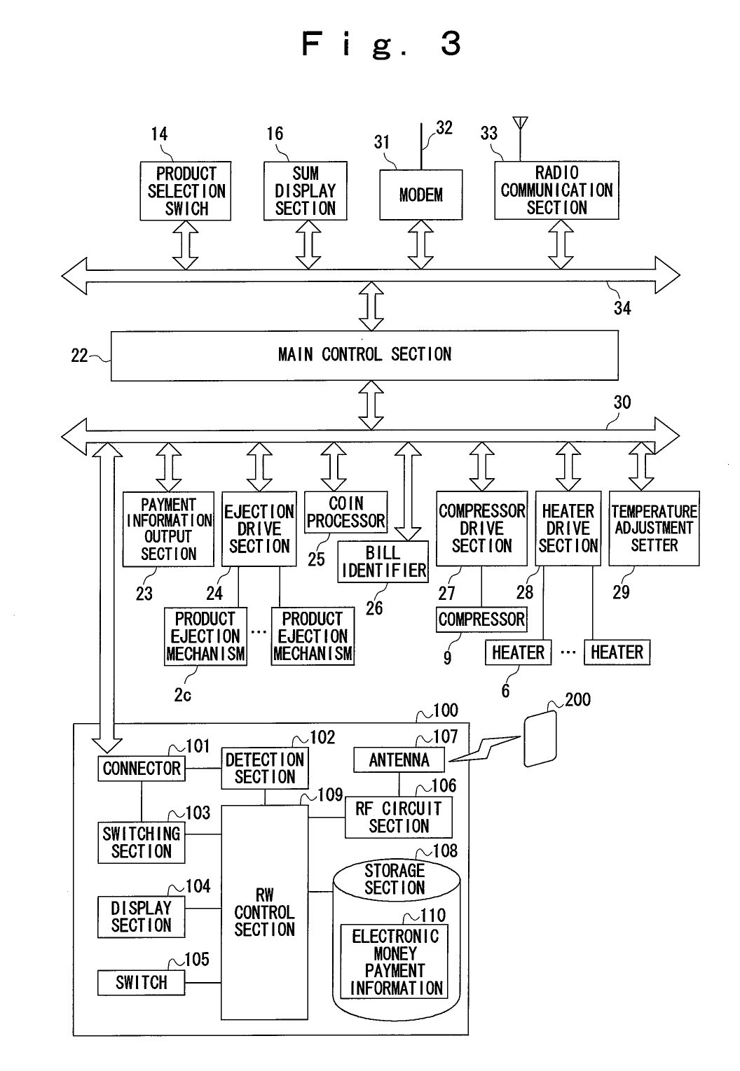

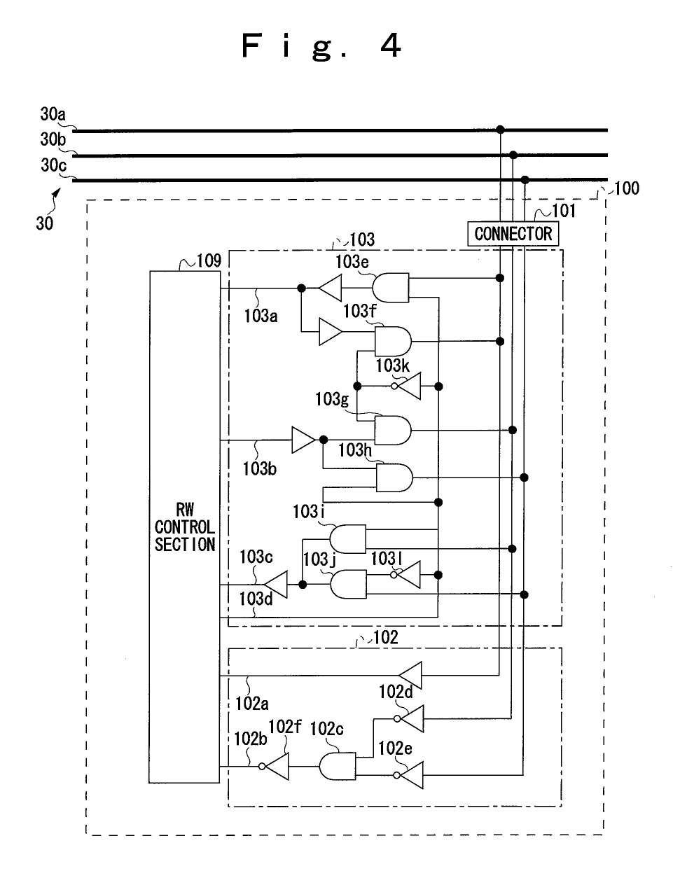

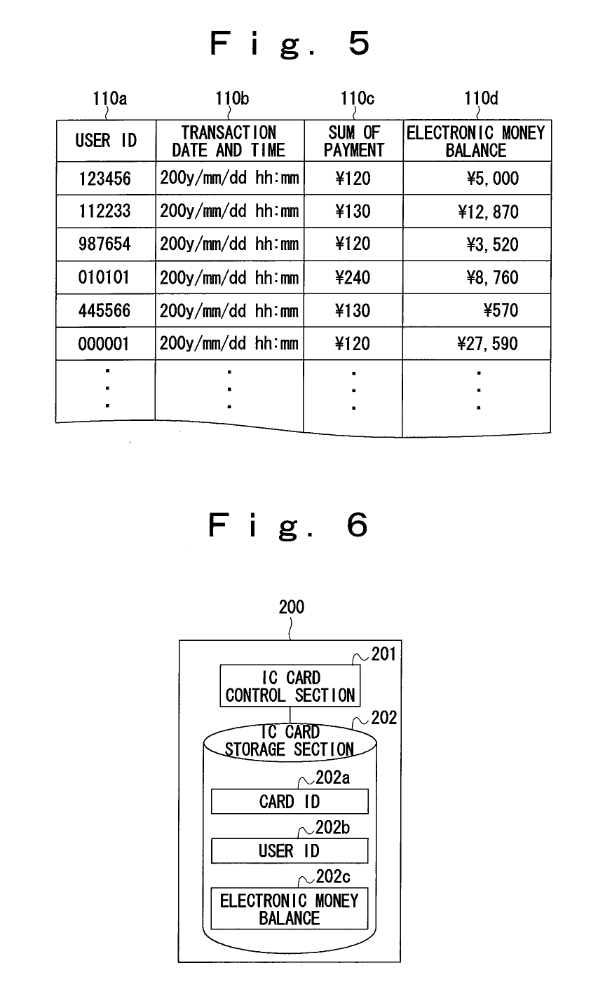

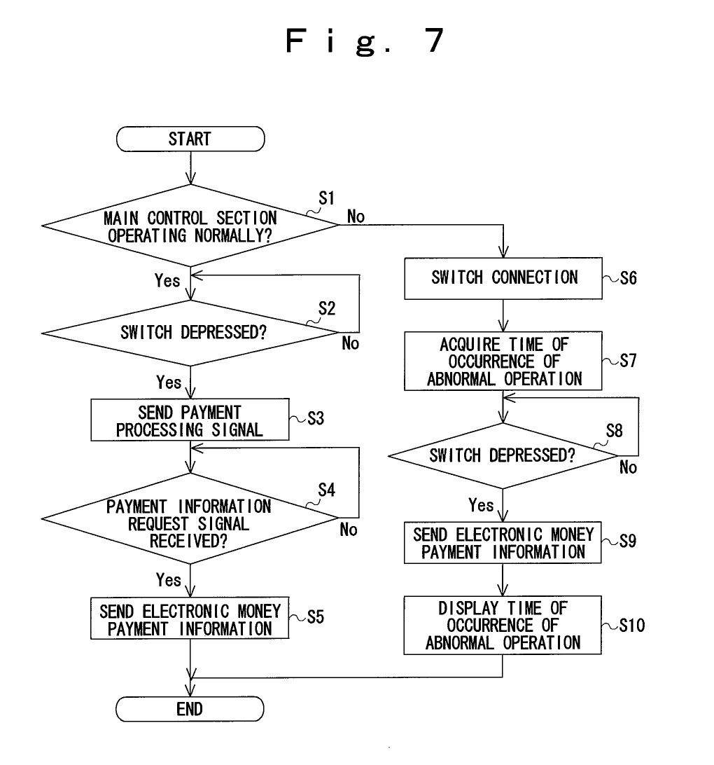

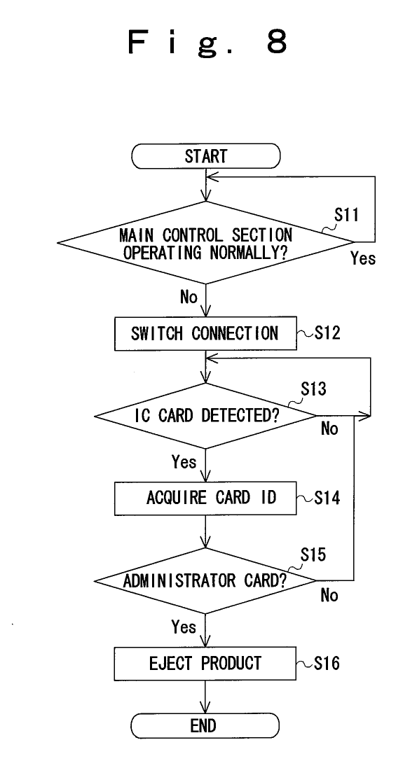

FIG. 1 to FIG. 8 show an embodiment of the present invention, FIG. 1 is a perspective view of an automatic vending machine, FIG. 2 is a side cross-sectional view of the automatic vending machine shown in FIG. 1, FIG. 3 is a block diagram showing the configuration of a control system of the automatic vending machine shown in FIG. 1, FIG. 4 illustrates logical circuits of the detection section and switching section, FIG. 5 shows an example of a data structure of electronic money payment information, FIG. 6 is a functional configuration diagram of a contactless IC card, FIG. 7 is a flow chart illustrating the operation of the RW control section when closing processing on payment is performed and FIG. 8 is a flow chart illustrating the operation of the RW control section when a product is carried out as a master apparatus.

First, the structure of the automatic vending machine will be explained with reference to FIG. 1 and FIG. 2.

An automatic vending machine body 1 is box-shaped and contains a heat insulating chamber 1a whose front side is left open. The heat insulating chamber 1a is segmented into a plurality of product storages SR arranged in the width direction of the automatic vending machine body 1 by means of heat insulating partition boards (not shown).

In each product storage SR, product storage racks 2 made up of serpentine racks are arranged. Each product storage rack 2 has a product slot 2a at the top front and stores products C such as canned beverage, bottled beverage and plastic bottled beverage stacked sideways in a serpentine storage passage 2b. Furthermore, a product ejection mechanism 2c for dropping and ejecting one stored product C onto a chute board 3 is provided at the bottom of each product storage rack 2. Furthermore, each product storage rack 2 arranged for each product storage SR is provided with a sold-out detection sensor (not shown) for detecting the presence/absence of the product C for each storage passage 2b. Not only the serpentine rack but also other types of rack that can eject stored products one by one as in the case of the serpentine rack can be used for this product storage rack 2.

Furthermore, the chute board 3 and a duct board 4 are provided in each product storage SR from the bottom to the back. An evaporator 5, an electric heater 6 and a cooling/heating air circulation fan 7 or the like out of freezer components are arranged in spaces behind the chute board 3 and duct board 4 and the space behind the duct board 4 is configured as a duct D. Furthermore, a temperature sensor (not shown) for detecting the temperature of each product storage SR is provided inside the product storage SR.

A machine room MR is provided below a bottom plate 1b of the heat insulating chamber 1a and a condenser 8, a compressor 9 and expanding means (not shown) and a fan for exhaust heat 10 or the like out of the freezer components are arranged in this machine room MR.

Furthermore, a heat insulating inner door 11 which covers the front opening in a freely opening/closing manner is provided in front of the heat insulating chamber 1a. Packing (no reference numeral assigned) for keeping the product storage SR airtight when the inner door 11 is closed is provided at front ends (the lower front end corresponds to the front end of the bottom plate 1b) in the vertical and horizontal directions of the heat insulating chamber 1a and at the front end of each partition board, and each product storage SR constitutes an independent heat insulating space when the inner door 11 is closed. Furthermore, a plurality of window holes 11a corresponding to the chute boards 3 of the respective product storages SR are formed at the bottom of the inner door 11 and each window hole 11a is provided with a flap door 11b which can be pushed open by the product C slipping down through the chute board 3.

That is, in this automatic vending machine, each product storage SR forms an independent heat insulating space and since each product storage SR is provided with the evaporator 5 and electric heater 6 independently, it is possible to select and perform any one of three modes of cooling, heating and non-cooling/heating using a temperature adjustment setter 29 which will be described later (see FIG. 3).

An outer door 12 is provided in the front opening of the automatic vending machine body 1 in a freely opening/closing manner and a transparent board 12a made of an acrylic plate is provided in the upper part of the surface of this outer door 12. Furthermore, an exhibition chamber 13 which exhibits a plurality of product samples S is provided behind the transparent board 12a. Furthermore, a product selection switch 14 is provided below each product sample S. Each product selection switch 14 is formed of an oblong push button, and a sellable lamp (not shown) is provided at one end thereof in the width direction and a sold-out lamp (not shown) is provided at the other end in the width direction. The sellable lamp is composed of an LED that emits light in a predetermined color (e.g., green), turns on when the sum of money equal to or more than the selling price of the product C corresponding to the product selection switch 14 to indicate that the product C can be sold. The sold-out lamp is made to light up characters of “sold out” with an LED in a predetermined color (e.g., red) and turns on when the product C corresponding to the product selection switch 14 is sold out to indicate that the product C cannot be sold.

Furthermore, the front side of the outer door 12 is provided with a coin slot 15, a sum display section 16, a bill slot 17, a coin return slot 18, a product ejection slot 19 and a reader/writer 100 in the layout shown in FIG. 1. The product ejection slot 19 is provided with a flap door 20 which can be manually opened and a product catching board 21 that catches the product C discharged from the flap door 11b is provided inside.

Next, the configuration of the control system of the automatic vending machine shown in FIG. 1 and FIG. 2 will be explained with reference to FIG. 3.

The main control section 22 is made up of a computer equipped with a CPU, RAM, ROM, timer circuit or the like and operates as a master apparatus that controls a control apparatus (slave apparatus) provided in the automatic vending machine body 1. Explaining more specifically, the main control section 22 is connected with a payment information output section 23, ejection drive section 24, coin processor 25, bill identifier 26, compressor drive section 27, heater drive section 28, temperature adjustment setter 29 and reader/writer 100 via a first transmission path 30 and also is connected with each product selection switch 14, sum display section 16, modem 31 and radio communication section 33 via a second transmission path 34, and the main control section 22 is designed to control the above described respective devices by transmitting control signals via each transmission path 30, 34. Furthermore, the main control section 22 is connected with a sold-out detection section (not shown) that detects the presence/absence of the product C in the product storage rack 2 arranged for each product storage SR for each storage passage 2b, a temperature detection section (not shown) that detects the temperature of each product storage SR via the first transmission path 30. Of course, the first transmission path 30 and the second transmission path 34 may also be configured by one transmission path. The main control section 22 is provided with a storage device (not shown) that stores money payment information indicating the sales of products C sold based on the deposited money.

The payment information output section 23 is a known printer and prints on a predetermined sheet and outputs the money payment information stored in the storage device of the main control section 22 and the electronic money payment information 110 which will be described later stored in the reader/writer 100 based on a control signal from the main control section 22.

The ejection drive section 24 is intended to control the operation of the product ejection mechanism 2c provided for each product storage rack 2 and more specifically the operation of an actuator such as solenoid used for the product ejection mechanism 2c, and operates the predetermined product ejection mechanism 2c based on a control signal from the main control section 22 and ejects a desired product.

The coin processor 25 and the bill identifier 26 are arranged inside the outer door 12 and the coin processor 25 performs true-false identification, counting and storage of coins deposited through the coin slot 15 and sends data on the sum of money of the deposited coins to the main control section 22. The bill identifier 26 performs true-false identification, counting and storage of the bills deposited through the bill slot 17 and sends data on the sum of money of the deposited bills to the main control section 22.

The compressor drive section 27 is intended to control the operation of the compressor 9 that makes up the freezer, or more specifically control the operation of the motor to drive the compressor 9 and performs desired compressor drive based on a control signal from the main control section 22.

The heater drive section 28 is intended to control energization for each electric heater 6 and perform energization for a predetermined electric heater 6 based on a control signal from the main control section 22.

The temperature adjustment setter 29 is intended to select any one of the aforementioned three modes for each product storage SR, provided with a mode selection push button switch or the like and sends data on the selected mode to the main control section 22.

As shown in FIG. 4, the first transmission path 30 is constructed of a sync signal line 30a to transmit a sync signal transmitted from a master apparatus to a slave apparatus, a transmission signal line 30b to transmit a control signal transmitted from the master apparatus to the slave apparatus and a reception signal line 30c to transmit a signal transmitted from the slave apparatus to the master apparatus.

The modem 31 is intended to perform data communication with an external server or the like using a public telephone line 32 or the like and the radio communication section 33 is intended to perform data communication with an external server or the like using a cellular phone network or PHS phone network or the like.

Hereinafter, the configuration of the reader/writer for an automatic vending machine according to this embodiment will be explained.

The reader/writer 100 reads/writes an electronic money balance 202c stored in a contactless IC card 200 as an information storage medium based on a control signal from the main control section 22 and thereby performs payment processing on electronic money, and operates, when the main control section 22 is operating normally, as a slave apparatus and operates, when an abnormal operation of the main control section 22 is detected, to control each of the devices 23 to 29 as a master apparatus. Furthermore, the reader/writer 100 is provided with a connector 101, detection section 102, switching section 103, display section 104, switch 105, RF circuit section 106, antenna 107, storage section 108 and reader/writer control section 109 (hereinafter referred to as “RW control section 109”) and the RW control section 109 is connected with the respective devices 102 to 106 and 108.

The connector 101 is used as an interface section to connect the detection section 102 and switching section 103 with the first transmission path 30 and one connector 101 is provided inside the reader/writer 100.

The detection section 102 is intended to detect the operating condition of the main control section 22 and provided with a sync signal line 102a, one end of which is connected to the RW control section 109 and the other end of which is connected to the sync signal line 30a of the first transmission path 30 through the connector 101, a reception signal line 102b, one end of which is connected to the RW control section 109 and the other end of which is connected to each of the signal lines 30b, 30c of the first transmission path 30 through the connector 101, an AND circuit 102c and a plurality of NOT circuits 102d, 102e, 102f in the layout shown in FIG. 4. Signals transmitting through the transmission signal line 30b and reception signal line 30c of the first transmission path 30 are inputted to the AND circuit 102c after being inverted by the NOT circuits 102d, 102e. Furthermore, the output signal of the AND circuit 102c is sent out to the RW control section 109 after being inverted by the NOT circuit 102f. That is, the output signal of the AND circuit 102b becomes “Low” level when both signals transmitting through the transmission signal line 30b and reception signal line 30c of the first transmission path 30 are at “Low” level.

This embodiment judges that the main control section 22 operates abnormally when a sync signal from the main control section 22 has not been transmitted to the RW control section 109 for a predetermined time, when no signal has been transmitted from the transmission signal line 30b of the first transmission path 30 for a predetermined time after a sync signal is transmitted from the main control section 22 to the RW control section 109 or when a “Low” level signal is transmitted from the reception signal line 102b of the detection section 102 to the RW control section 109 for a predetermined time continuously.

The switching section 103 is intended to switch the connection with the main control section 22 to the connections with the other devices 23 to 29 when an abnormal operation of the main control section 22 is detected, and provided with a sync signal line 103a, one end of which is connected to the RW control section 109 and the other end of which is connected to the sync signal line 30a of the first transmission path 30 through the connector 101, a transmission signal line 103b and a reception signal line 103c, one end of which is connected to the RW control section 109 and the other end of which is connected to each of the signal lines 30b, 30c of the first transmission path 30 trough the connector 101, an identification signal line 103d for transmitting an identification signal indicating whether the reader/writer 100 is operating as a slave apparatus or master apparatus, a plurality of AND circuits 103e to 103j, and a plurality of NOT circuits 103k and 1031 in the layout shown in FIG. 4. The RW control section 109 sends out a “High” level signal when the reader/writer 100 is operating as the slave apparatus and a “Low” level signal when it is operating as the master apparatus to the identification signal line 103d respectively.

Here, when the reader/writer 100 is operating as the slave apparatus, one input signal of the AND circuits 103e, 103h and 103i is always at “High” level, and therefore the RW control section 109 can receive a sync signal which transmits through the sync signal line 30a of the first transmission path 30 and transmit a signal to the reception signal line 30c of the first transmission path 30. Furthermore, the RW control section 109 can receive a signal transmitting through the transmission signal line 30b of the first transmission path 30. In this case, since the output signals of the AND circuits 103f, 103g and 103j are always at “Low” level, the RW control section 109 neither transmits any sync signal on the sync signal line 103a to the sync signal line 30a of the first transmission path 30 nor transmits any signal to the transmission signal line 30b of the first transmission path 30. Furthermore, the RW control section 109 does not receive any signal on the reception signal line 30c of the first transmission path 30.

Furthermore, when the reader/writer 100 is operating as the master apparatus, one input signal of the AND circuits 103f, 103g and 103j is always at “High” level, and therefore the RW control section 109 can send out the sync signal transmitting through the sync signal line 103a to the sync signal line 30a of the first transmission path 30 and send out a signal to the transmission signal line 30b of the first transmission path 30. Furthermore, the RW control section 109 can also receive a signal sent out to the reception signal line 30c of the first transmission path 30. In this case, since the output signals of the AND circuits 103e, 103h and 103i are always at “Low” level, the RW control section 109 neither receives any sync signal on any sync signal line 30a of the first transmission path 30 nor sends out the signal to the reception signal line 30c of the first transmission path 30. Furthermore, the RW control section 109 never receives any signal on the transmission signal line 30b of the first transmission path 30.

The display section 104 is a known display device such as a liquid crystal display and displays character information and image information received from the RW control section 109 in a predetermined size.

The switch 105 is intended to instruct closing processing on payment using money and electronic money and transmits a predetermined payment processing signal to the RW control section 109 when depressed.

The RF circuit section 106 is intended to perform contactless data communication between the RW control section 109 and a contactless IC card 200 through the antenna 107 and is constructed of a known AD/DA converter and a rectification circuit or the like.

The storage section 108 is a rewritable storage element such as an EEPROM and stores electronic money payment information 110 indicating the sales of sold products C based on the balance of the electronic money. As shown in FIG. 5, the electronic money payment information 110 is composed of a plurality of payment records such as a user ID 110a, transaction date and time 110b, an amount of payment 110c and an electronic money balance after payment 110d and the RW control section 109 stores new payment records when the payment processing on the electronic money is normally completed. Furthermore, the storage section 108 stores control programs and control signals beforehand to control the payment information output section 23, ejection drive section 24, compressor drive section 27, heater drive section 28 and temperature adjustment setter 29 respectively.

The RW control section 109 is made up of a computer equipped with a CPU, RAM, ROM and timer circuit or the like and intended to control various devices in the reader/writer 100. Furthermore, when the reader/writer 100 is operating as the slave apparatus, the RW control section 109 performs payment processing on the electronic money based on a control signal of the main control section 22 and controls, when the main control section 22 operates abnormally, such that the reader/writer 100 operates as the master apparatus. More specifically, in order to operate as the master apparatus, the RW control section 109 transmits a “Low” level signal to the identification signal line 103d of the switching section 103. This allows the connection with the main control section 22 through the first transmission path 30 to be switched to the connections with the payment information output section 23, ejection drive section 24, compressor drive section 27, heater drive section 28 and temperature adjustment setter 29. Furthermore, the RW control section 109 executes the control program of the storage section 108 and sends a control signal and thereby controls the payment information output section 23, ejection drive section 24, compressor drive section 27, heater drive section 28 and temperature adjustment setter 29 respectively.

Next, the configuration of the contactless IC card 200 which carries out payment processing on the electronic money with the reader/writer 100 will be explained.

A coil-shaped antenna (not shown) for transmitting/receiving signals to/from the reader/writer 100 on a contactless basis and an IC chip connected to the antenna are embedded in the contactless IC card 200. As shown in FIG. 6, this IC chip is provided with an IC card control section 201 that controls the circuits in the IC chip and an IC card storage section 202 that stores various types of information.

The IC card control section 201 is provided with a CPU and a memory such as RAM, ROM and performs update or read processing on the various types of information stored in the IC card storage section 202 based on IC card commands received through the antenna.

The IC card storage section 202 is a rewritable storage element such as an EEPROM and stores a card ID 202a, user ID 202b and electronic money balance 202b. The card ID 202a is intended to identify the contactless IC card 200 and is given an ID which differs among a plurality of contactless IC cards 200. The user ID 202b is intended to identify the user of an electronic money service and is given an ID which differs among different contactless IC cards 200 used for the electronic money service. This embodiment uses the contactless IC card 200 having a predetermined value added to the card ID 202a as an administrator card of the automatic vending machine and the operation of the RW control section 109 when communicating with the administrator card will be described later.

In the automatic vending machine configured as shown above, the main control section 22 is designed to sell the product C according to the sum of money and the balance of the electronic money and adjust the temperature of the product C or the like as the master apparatus. Here, the operation of the main control section 22 when the user purchases the product C using money or electronic money will be explained.

First, the operation when purchasing the product C using money will be explained. When the sum of money deposited into the coin slot 15 or bill slot 17 is acquired from the coin processor 25 or bill identifier 26, the main control section 22 causes the sum display section 16 to display the deposited sum and causes a sellable lamp of a product selection switch 14 corresponding to the product C that can be sold with the deposited sum to turn on. When the user selects the sellable product C, the main control section 22 operates the product ejection mechanism 2c of the product storage rack 2 in which the selected product is stored and ejects the product. Next, the main control section 22 stores the price of the product C ejected and the number of products sold or the like in the money payment information of the storage device.

Next, a case where the product C is purchased using electronic money will be explained. First, the main control section 22 transmits a control signal to acquire the electronic money balance 202c of the contactless IC card 200 to the reader/writer 100. In this case, the RW control section 109 transmits an IC card command to acquire the card ID 202a of the contactless IC card 200 to outside through the RF circuit section 106 and antenna 107 every time a predetermined time elapses. Here, when the IC card control section 201 of the contactless IC card 200 receives the IC card command, it sends the card ID 202a of the IC card storage section 202 to the reader/writer 100. Next, upon acquiring the card ID 202a, the RW control section 109 sends an IC card command to read the user ID 202b and electronic money balance 202c to the contactless IC card 200 and thereby acquires the user ID 202b and electronic money balance 202c. The RW control section 109 sends the acquired electronic money balance 202c to the main control section 22.

The main control section 22 causes the sum display section 16 to display the electronic money balance 202c acquired from the reader/writer 100 and causes a sellable lamp of the product selection switch 14 corresponding to a product C that can be sold with the electronic money balance 202c to turn on. When the user selects the sellable product C, the main control section 22 sends the price information of the selected product and a control signal to carry out payment processing on electronic money to the reader/writer 100. In this case, the RW control section 109 sends an IC card command to subtract the price of the selected product from the electronic money balance 202c to the contactless IC card 200 and thereby updates the electronic money balance 202c of the contactless IC card 200. Upon receiving a signal indicating that the update of the electronic money balance 202c has been normally completed from the RW control section 109, the main control section 22 operates the product ejection mechanism 2c of the product storage rack 2 in which the selected product is stored and ejects the product. When the update of the electronic money balance 202c has been normally completed, the RW control section 109 stores a payment record made up of the user ID 202b acquired from the contactless IC card 200, transaction date and time, price information (sum of payment) of the selected product and the updated electronic money balance 202c in electronic money payment information 110 of the storage section 108.

Next, the operation of the RW control section 109 when closing processing on payment using money and electronic money will be explained with reference to the flow in FIG. 7. First, the operation when the main control section 22 is normally operating will be explained and then the operation when the main control section 22 operates abnormally will be explained. Suppose the reader/writer 100 is operating as the slave apparatus in an initial condition.

First, the RW control section 109 judges whether or not the main control section 22 is normally operating based on the signal received from the detection section 102 (step S1). Next, when the switch 105 is depressed (step S2) after judging that the main control section 22 is normally operating, the RW control section 109 sends the payment processing signal received from the switch 105 to the main control section 22 through the switching section 103, connector 101 and reception signal line 30c of the first transmission path 30 (step S3). On the other hand, upon receiving the payment processing signal from the reader/writer 100, the main control section 22 sends a predetermined payment information request signal to the reader/writer 100.

Upon receiving the payment information request signal from the main control section 22 (step S4), the RW control section 109 sends the electronic money payment information 110 stored in the storage section 108 to the main control section 22 (step S5). The main control section 22 sends the electronic money payment information 110 received from the reader/writer 100 and the money payment information on the storage device to the payment information output section 23 and causes it to print out and output this information.

Next, a case where the main control section 22 operates abnormally will be explained. When judging that the main control section 22 is operating abnormally, the RW control section 109 sends out a “Low” level signal to the identification signal line 103d of the switching section 103 and thereby switches the connection with the main control section 22 to the connection with each of the devices 23 to 29 (step S6). In the processing hereinafter, the reader/writer 100 will operate as the master apparatus. Next, the RW control section 109 acquires the time of connection switching from the timer circuit as the time of the occurrence of the abnormal operation of the main control section 22 (step S7) and then if the switch 105 is depressed (step S8), it sends the electronic money payment information 110 and control signal of the storage section 108 to the payment information output section 23 through the switching section 103, connector 101 and transmission signal line 30b of the first transmission path 30 (step S9). In this case, the payment information output section 23 prints out and outputs the electronic money payment information 110 to a predetermined sheet. Furthermore, the RW control section 109 causes the display section 104 to display the time of the occurrence of the abnormal operation of the main control section 22 acquired in step S7 (step S10).

Though the explanation has been omitted in the above described flow, the RW control section 109 may also be adapted to send the temperature of each product storage SR detected by the temperature detection section (not shown) to the payment information output section 23 together with the electronic money payment information 110 to thereby print out and output the electronic money payment information 110 and temperature information of each product storage SR to a predetermined sheet.

Furthermore, the RW control section 109 may also be adapted to send the time of the occurrence of the abnormal operation of the main control section 22 acquired in above step S7 to the payment information output section 23 together with the electronic money payment information 110 to thereby print out and output the electronic money payment information 110 and the time of the occurrence of the abnormal operation of the main control section 22 to a predetermined sheet.

Next, the operation of the RW control section 109 when the reader/writer 100 ejects the product as the master apparatus will be explained with reference to the flow in FIG. 8. Suppose the reader/writer 100 is operating as the slave apparatus in an initial condition.

When judging that the main control section 22 is operating abnormally (step S11), the RW control section 109 sends out a “Low” level signal to the identification signal line 103d of the switching section 103 and thereby switches the connection with the main control section 22 to the connection with each of the devices 23 to 29 (step S12). Next, the RW control section 109 sends out an IC card command to acquire the card ID 202a of the contactless IC card 200 through the RF circuit section 106 and antenna 107 every time a predetermined time elapses, thereby detects the IC card (step S13) and acquires the card ID 202a sent from the contactless IC card 200 (step S14). When the acquired card ID 202a is used as an administrator card (step S15), the RW control section 109 sends a control signal to the ejection drive section 24. In this case, the ejection drive section 24 operates the product ejection mechanism 2c provided for each product storage rack 2 and thereby ejects the product C (step S16). When the RW control section 109 identifies the administrator card in this way, it is possible to easily eject the product C.

Thus, the reader/writer for an automatic vending machine 100 of this embodiment is provided with the detection section 102 that detects an operating condition of the main control section 22, the switching section 103 that switches, when the detection section 102 has detected a predetermined abnormal operation, the connection with the main control section 22 to the connection with the payment information output section 23 provided for the automatic vending machine and the RW control section 109 that reads/writes the electronic money balance 202c stored in the contactless IC card 200 based on the signal received from the main control section 22, thereby performs payment processing on electronic money and performs control such that the electronic money payment information 110 is outputted from the payment information output section 23 when the connection is switched by the switching section 103, and therefore when the main control section operates abnormally, the operator of the automatic vending machine can acquire electronic money payment information 110 without directly connecting a device to acquire the electronic money payment information 110 to the reader/writer for an automatic vending machine 110. Therefore, since the electronic money payment information 110 is easily outputted, the operator of the automatic vending machine can confirm and collect the electronic money payment information 110 in a short time.

Furthermore, when the detection section 102 detects a predetermined abnormal operation, the switching section 103 switches the connection with the main control section 22 to the connection with the ejection drive section 24 that drives the product ejection mechanism 2c, and when the switching section 103 switches the connection with the main control section 22 to the connection with the ejection drive section 24 and when data is communicated with the administrator card 200 having the predetermined card ID 202a, the RW control section 109 controls the ejection drive section 24 such that the product C is ejected from the product ejection mechanism 2c, and therefore it is possible to eject the product C based on the control of the RW control section 109 and easily eject the product C stored in the automatic vending machine even when the main control section 22 does not operate normally.

Furthermore, since the RW control section 109 causes the payment information output section 23 to output the temperature information of the product storage SR together with the electronic money payment information 110, it is possible to confirm the thermal insulating condition of the product C stored in the product storage SR when the main control section 22 operates abnormally. Therefore, it is possible to easily judge whether or not the stored product C needs to be ejected based on the thermal insulating condition of the stored product C and thereby reduce deterioration of the quality of the stored product C.

Furthermore, since the RW control section 109 causes the payment information output section 24 to output the time of occurrence of an abnormal operation of the main control section 22 together with the electronic money payment information 110, it is possible to easily know the time of the occurrence of an abnormal operation of the main control section 22. Therefore, since it is possible to judge whether or not the stored product C needs to be ejected based on the time of the occurrence of an abnormal operation, it is possible to reduce deterioration of the quality of the stored product C.

Furthermore, since one connector 101 is provided to connect the detection section 102 and switching section 103 and the first transmission path 30, it is possible to connect the detection section 102 and switching section 103 to the first transmission path 30 using an interface common thereto and simplify the configuration of the reader/writer 100.

The above described embodiment is merely one specific example and the present invention is by no means limited to the above described embodiment. For example, the above described embodiment has shown the case where the contactless IC card 200 is used as an information storage medium, but in addition, a cellular phone equipped with an RFID (Radio Frequency Identification) tag or IC chip may also be used as the information storage medium.

Furthermore, the above described embodiment has shown the case where the card ID 202a is used as identification information, but the card ID 202b may also be used as the identification information.

1. A reader/writer for an automatic vending machine provided so as to be connected to a main control section that controls a control apparatus in the automatic vending machine via a transmission path, comprising:
detection means for detecting an operating condition of the main control section;
switching means for switching, when the detection means detects a predetermined abnormal operation, the connection with the main control section to a connection with a payment information output section provided for the automatic vending machine; and
control means for performing control such that payment processing on electronic money is carried out by reading/writing an electronic money balance stored in a predetermined information storage medium based on a signal received from the main control section and when the connection is switched by the switching means, the payment processing information on the electronic money is outputted from the payment information output section.

2. The reader/writer for an automatic vending machine according to claim 1, wherein when the detection means detects a predetermined abnormal operation, the switching means switches the connection with the main control section to a connection with the ejection drive section that drives a product ejection mechanism, and
when the switching means switches the connection with the main control section to the connection with the ejection drive section and data is communicated with an information storage medium having predetermined identification information, the control means can control the ejection drive section such that a product is ejected from the product ejection mechanism.

3. The reader/writer for an automatic vending machine according to claim 1, wherein the control means causes the payment information output section to output payment processing information on the electronic money and temperature information on a product storage.

4. The reader/writer for an automatic vending machine according to claim 1, wherein the control means causes the payment information output section to output payment processing information on the electronic money and a time of occurrence of an abnormal operation of the main control section.

5. The reader/writer for an automatic vending machine according to claim 1, further comprising an interface for connecting at least one of the detection means, switching means and control means with the transmission path.
